(19) United States
(12) Patent Application Publication
(10) Pub. No.: US 2015/0340770 A1
(43) Pub. Date: Nov. 26, 2015

(54) Antenna Assembly and System

(71) Applicant: THE SECRETARY OF STATE FOR BUSINESS, INNOVATION & SKILLS OF HER MAJESTY'S BRITANNIC GOVERNMENT, London (GB)

(72) Inventors: Tian Hong Loh, Teddingtom (GB); Haitao Liu, Beijing (CN); Steven Gao, Kent (GB)

(21) Appl. No.: 14/652,951

(22) PCT Filed: Dec. 20, 2013
(86) PCT No.: PCT/GB2013/053411

§ 371 Date: Jun. 17, 2015

(30) Foreign Application Priority Data
Dec. 21, 2012 (GB) 1223250.0

(51) Int. Cl. H01Q 21/28; H01Q 3/44; H01Q 3/36; H01Q 19/28

(52) U.S. Cl. CPC H01Q 21/28; H01Q 19/28; H01Q 3/44; H01Q 3/36

(57) ABSTRACT

An antenna system includes a plurality of antenna assemblies. The antenna assemblies include a driven component and a director array to increase the gain of the antenna assembly. For each antenna assembly of the plurality of antenna assemblies, the driven component and director array are disposed in an antenna plane. Each antenna assembly is arranged in a different geometrical plane.

The present application relates to an antenna assembly and system.

### INTRODUCTION

Smart antennas are one of the key technologies for future satellite communications, air-borne and terrestrial wireless communication systems. Such antennas can significantly increase the capacity of wireless communication systems by providing diversity gain and spatial division multiplexing.

Smart antenna systems comprise an array of multiple antenna elements and can dynamically generate multiple beams towards desired users while forming a null towards the interference. In order to achieve spatial electromagnetic power combining, smart antennas should distribute the signal into every antenna element with the correct phase and amplitude. Such antenna elements can either be active radiators or parasitic radiators.

Smart antennas based on active antennas require coherent transceivers with digital beam-forming (DBF) units, which allocate appropriate phase and amplitude distributions through a radio frequency (RF) phase-shifter network. The main problems of this technology include the complexity, large physical size, high power consumption and high cost.

To reduce the size, cost and power consumption, a folded monopole electronically steerable switched parasitic antenna has been proposed [1], [2]. The pattern steering relies on switching between the open circuit and the closed circuit states in the parasitic elements and the PIN diodes are used as the switching components. In the switched parasitic antenna, there is usually one driven element connected with RF front end. The RF energy is distributed to every parasitic radiator by electromagnetic coupling. In [1], a low profile smart antenna is constructed by using a short mono-cone monopole (lower diameter 4 mm and upper diameter 8 mm) at the centre and twelve parasitic folded monopoles surrounding the centre. Each parasitic folded monopole is loaded by a PIN diode. By controlling the DC voltages applied to the PIN diodes, the radiation pattern of the folded monopole switched parasitic antenna can be steered in the horizontal plane from 0° to 360°. Since the folded monopoles act as reflectors and there are no directors employed in the design, the small switched parasitic antenna in [3] reports a gain of 4 dBi. Such an antenna gain is not sufficient for applications in small satellite and air-borne systems. However, it is difficult to increase the gain of the switched parasitic antenna further by adding more reflectors.

The present invention seeks to provide an improved antenna assembly, system and method.

According to an aspect of the invention, there is provided an antenna system as in claim 1.

In embodiments, a driven component operable to emit or receive radiation in a particular path or direction is configured to emit or receive radiation in that path or direction.

In embodiments of the invention, each antenna plane is non-perpendicular with at least one other antenna plane, preferably is non-perpendicular with all other antenna planes of the plurality of antenna assemblies.

In some embodiments, the driven components of the antenna assemblies of the plurality of antenna assemblies are all disposed in a plane which is perpendicular to all the antenna planes of the plurality of antenna assemblies.

According to an aspect of the invention, there is provided an antenna system including a plurality of antenna assemblies, each antenna assembly of the plurality of antenna assemblies including:
a driven component configured to emit or receive radiation; and
a director array disposed in a path along which the driven component is configured to emit or receive radiation to increase the gain of the antenna assembly, the director array including at least one director;
wherein for each antenna assembly of the plurality of antenna assemblies, the driven component and director array are disposed in an antenna plane;
wherein each antenna assembly of the plurality of antenna assemblies is arranged with its antenna plane spaced in a direction perpendicular to its antenna plane from the antenna plane of each of the other antenna assemblies of the plurality of antenna assemblies.

In embodiments, at least one point of the antenna plane of each of the plurality of antenna assemblies is spaced or offset in a direction perpendicular to that antenna plane from the antenna plane of each of the other antenna assemblies of the plurality of antenna assemblies. In preferred embodiments, the direction of spacing between each of the antenna planes is the same. The antenna planes can be mutually inclined. However, in preferred embodiments, the antenna planes are parallel and the whole of the antenna plane of each of the plurality of antenna assemblies is spaced or offset in a perpendicular direction from the antenna plane of each of the other antenna assemblies of the plurality of antenna assemblies.

An antenna plane of an individual antenna assembly is the plane in which that individual antenna assembly is configured to emit and/or receive radiation. In embodiments, the driven component and the at least one director are arranged to be perpendicular to their antenna plane.

Preferably, the antenna assemblies are coupled by a phase shifter to allow selection of a direction for receiving or emitting radiation which is not parallel to an antenna plane. Preferred embodiments in this way are able to electronically steer a radiation pattern in both azimuth and elevation planes. This feature makes this two-element array suitable for applications requiring overcoming the pointing loss.

According to an aspect of the present invention there is provided an antenna assembly, including:

a driven component configured to emit or receive radiation at a wavelength λ; and

a director array disposed in a path along which the driven component is configured to emit or receive radiation to increase the gain of the antenna assembly, the director array including at least one director; wherein every director of the director array has a height of substantially ≦0.3λ. The height of each director is in a direction parallel to a direction of oscillation of radiation which the driven component is configured to emit or receive.

An antenna assembly according to this aspect of the invention can be used for any or all of the antenna assemblies of the antenna system of the aspect of the invention recited above.

In embodiments, every director of the director array has a height of substantially ≦0.25λ.

In a preferred embodiment, the directors have a height of substantially 0.2 times the wavelength λ.

References herein to a perimeter of a tube are references to a perimeter of a perpendicular cross-section of that tube.

In preferred embodiments, a radius or perimeter of each of the at least one director and a distance of the director array from the driven component are configured to optimise m and β where the current along each director is me^{jB} times the current in the driven component or a driven element of the driven component. Optimising m and β can include providing a driven component which has a height substantially ≦0.5λ and maximising m while −π<β<0.

Preferred embodiments of the invention provide a small director array for a low profile smart antenna achieving higher gain.

Preferably, each director is arranged to be aligned with radiation which in operation the driven component is operable to emit or receive.

The driven component preferably includes a directional and preferably reconfigurable smart antenna.

In embodiments, each director of the director array includes a tube, preferably a hollow tube; the tube is preferably a cylinder. Although the tube being cylindrical is preferable, the tube can have any shape for its cross-section. The cross-section can for example be rectangular, triangular or elliptical. The tube can also be solid.

In preferred embodiments of the invention, the perimeter of each tube is equal to 2πr where r is from 0.05λ to 0.1λ, preferably from 0.07λ to 0.09λ, and most preferably about 0.08λ. Where a tube is a hollow cylinder or otherwise has a circular cross-section, it can have radius r. Where a tube has a non-circular cross-section, the dimensions of the tube can be selected appropriately so that its perimeter equals 2πr even though r itself may not be a physical dimension of the tube.

In some embodiments, r is from 5 mm to 15 mm, from 8 mm to 12 mm, or about 10 mm.

In preferred embodiments, a distance of the director array from the driven component, or from the closest director of the director array, along a path along which the driven component is configured to emit or receive radiation is from 0.15λ to 0.4λ, preferably from 0.19λ to 0.3λ, more preferably from 0.2λ to 0.25λ and most preferably about 0.2λ.

In some embodiments, the spacing between longitudinal axes of directors that are separated from the driven component along a direction along which the driven component is operable to receive or emit radiation is no less than 20 mm and no more than 35 mm, preferably 25 mm.

In embodiments, each director of the director array is switchable between a directing mode in which the director acts as a parasitic director, and a non-directing mode in which the director is substantially transparent to radiation at wavelength A.

In embodiments, each director of the director array is or includes a dipole or is or includes a monopole, which monopole can be coupled to a ground plane.

In embodiments, each director of the director array includes a first or upper tube, preferably a hollow cylinder, connected by a PIN diode to a second or lower tube, preferably a hollow cylinder, longitudinally offset from the first tube or from a ground plane.

The antenna assembly can include a control unit operable for each PIN diode selectively to forward bias the PIN diode to put the respective director into the directing mode, or to reverse bias the PIN diode to put the respective director into the non-directing mode.

The director array preferably includes at least one plurality of directors.

A distance between adjacent directors in the director array can be substantially the same as a distance of the director array from the driven element.

In embodiments, each plurality of directors includes at least 3 directors.

In embodiments, each plurality of directors forms an array at least 2 directors wide in a direction perpendicular to a direction along which the driven component is configured to receive or emit radiation.

In some embodiments, the at least one plurality of directors is more than one plurality of directors; and the pluralities of directors are angularly spaced around the driven component; and the driven component is configured to receive or emit radiation in the direction of any of the plurality of directors.

The driven component can be configured selectively to receive or emit radiation in the direction of any of the plurality of directors.

In some embodiments, there are no more than 3 directors aligned along any direction along which the driven component is configured to receive or emit radiation.

In some embodiments, the driven component includes a driven element at least partially surrounded by parasitic elements wherein the parasitic elements are of bent or curved configuration.

In some embodiments, the height of the driven element or driven component does not exceed one quarter of the wavelength of radiation at an operating frequency of the antenna assembly.

In some embodiments, the parasitic elements are angularly spaced around the driven element and are bent or curved towards the driven element.

The driven element and the parasitic elements can each include a dipole or include monopole, which monopole can be coupled to a ground plane.

Each of the parasitic elements can have an adjustable reflectivity, thereby to allow selection of a direction for the driven component to emit or receive radiation.

Each of the parasitic elements can be provided with a varactor to provide the adjustable reflectivity.

In embodiments, each director is substantially parallel to a direction of oscillation of radiation that the driven component is configured to emit or receive.

According to an aspect of the invention, there is provided an antenna system including a plurality of antenna assemblies, each antenna assembly being in accordance with the aspect of the invention described above;

wherein for each antenna assembly, the driven component and director array are disposed in an antenna plane;

wherein the antenna assemblies are arranged with their antenna planes mutually offset in a direction perpendicular to their antenna planes.

According to an aspect of the invention, there is provided an antenna system including a plurality of antenna assemblies, each antenna assembly including:

a driven component configured to emit or receive radiation; and

a director array disposed in a path along which the driven component is configured to emit or receive radiation to increase the gain of the antenna assembly, the director array including at least one director;

wherein for each antenna assembly, the driven component and director array are disposed in an antenna plane;

wherein the antenna assemblies are arranged with their antenna planes mutually offset in a direction perpendicular to their antenna planes.

According to an aspect of the invention, there is provided a method as in claim 31 or 34.

According to an aspect of the invention, there is provided a method of operating an antenna system, the system including: a first driven component; a first director array including at least one director; a second driven component; and a second director array including at least one director; wherein the first driven component and the first director array are disposed in a first antenna plane; wherein the second driven component and the second director array are disposed in a second antenna plane; wherein the first and second antenna planes are spaced in a direction perpendicular to the first antenna plane and in a direction perpendicular to the second antenna plane; the method including: operating the first and second driven components to emit or receive radiation at a wavelength λ with a mutual phase shift thereby to vary a direction along which radiation is emitted or received.
According to an aspect of the invention, there is provided a method of operating an antenna assembly, including:
providing a driven component of the antenna assembly;
providing a director array of the antenna assembly including at least one director; wherein every director of the director array has a height of substantially ≦0.3λ;
   operating the driven component to emit or receive radiation at a wavelength λ along a path in which is disposed the director array, thereby to increase the gain of the antenna assembly.

Preferably, the method includes switching at least one of the at least one director of the director array between a directing mode in which the director acts as a parasitic director, and a non-directing mode in which the director is substantially transparent to radiation at wavelength λ, thereby to vary the gain and/or direction along which the antenna assembly is configured to receive or emit radiation.

Preferably, the method further includes:

providing a second driven component;

providing a second director array including at least one director; wherein every director of the second director array has a height of substantially ≦0.3λ;

disposing the first driven component and the first director array in a first antenna plane;

disposing the second driven component and the second director array in a second antenna plane;

offsetting the first and second antenna planes in a direction perpendicular to the first and second antenna planes;

operating the first and second driven components to emit or receive radiation at a wavelength λ with a mutual phase shift thereby to vary a direction along which radiation is emitted or received.

According to an aspect of the invention, there is provided a method of operating an antenna system, including

providing a first driven component;

providing a first director array including at least one director;

providing a second driven component;

providing a second director array including at least one director;

disposing the first driven component and the first director array in a first

antenna plane;

disposing the second driven component and the second director array in a second antenna plane;

offsetting the first and second antenna planes in a direction perpendicular to the first and second antenna planes;

operating the first and second driven components to emit or receive radiation at a wavelength λ with a mutual phase shift thereby to vary a direction along which radiation is emitted or received.

Features of the various aspects described above are suitable for all aspects and accordingly features described with respect to one aspect can be applied to other aspects.

The Yagi-Uda antenna is a fixed beam parasitic radiator array that can achieve a high gain with one reflector and several directors. The theory behind Yagi-Uda shows that proper designed directors are the key components with which a higher gain can be achieved. Furthermore, the gain of the Yagi-Uda antenna depends on the number of directors used [4]-[6]. However, for a standard Yagi-Uda antenna, the length of its director is 0.45λ, which is much larger than the height of the antenna in [1]. To maintain the low profile of small smart antennas, embodiments of the invention provide a small director with low profile.

In embodiments of the invention, electrically small directors for increasing the antenna gain are configured as SDA. A fixed SDA integrated with a low profile antenna with fixed beam can be provided. The fixed SDA and the low profile antenna together form a low profile Yagi-Uda antenna.

In embodiments of the invention, reconfigurable small directors and reconfigurable SDA can be provided. The reconfigurable SDA can be provided with an enhanced low-profile switched parasitic antenna, showing its ability to increase the antenna and to improve the Forward-Backward Ratio (FBR).

Embodiments of the invention include reconfigurable small directors with an array consisting of two fixed SDAs, which enable the steering of the radiation pattern in the whole of azimuth plane and part of elevation plane.

A preferred embodiment includes a small director array (SDA) which is an antenna gain enhancing section of the low profile smart antenna which can be used as a fixed array or reconfigurable array using switched parasitic elements. Gain improvements up to +10 dBi are achieved in the SDA through a Yagi-Uda configuration using parasitic elements with a large diameter. The array height is reduced by 50% comparing with the standard Yagi-Uda antenna. The reconfigurable SDA uses an electronically steerable switched parasitic arrangement so that the beam can be steered from 0° to 360° in horizontal plane. The height of the reconfigurable SDA is 0.2λ. The measurements prove that the reconfigurable SDA can increase the antenna gain by 3 dB. The front to back ratio (FBR) shows significant improvement. The preferred SDA also has the advantages of low cost and low power consumption, thus being suitable for applications in small satellites, Unmanned Aerial Vehicles (UAV) and mobile terminals.

Furthermore, to steer the radiation pattern in both the azimuth and elevation planes, an array consisting of two reconfigurable SDA can be provided. Each SDA is connected with a low cost compact phase shifter, which comprises a compact branch line coupler and two varactors. This feature of steering its beam in both azimuth and elevation planes is very useful for automatically reducing the pointing loss in wireless communication system. The measured beam steering range of the two-element array is from −15° to 15° or even −20° to 20° in the elevation plane and from −10° to 10° in the azimuth plane.

Preferred embodiments of the invention are described below, by way of example only, with reference to the accompanying drawings, in which:

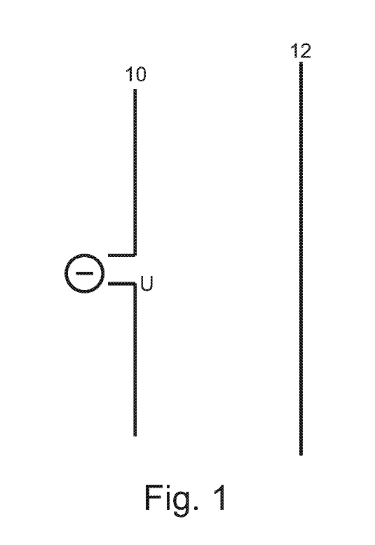

FIG. 1. is a schematic diagram of a Yagi-Uda antenna;

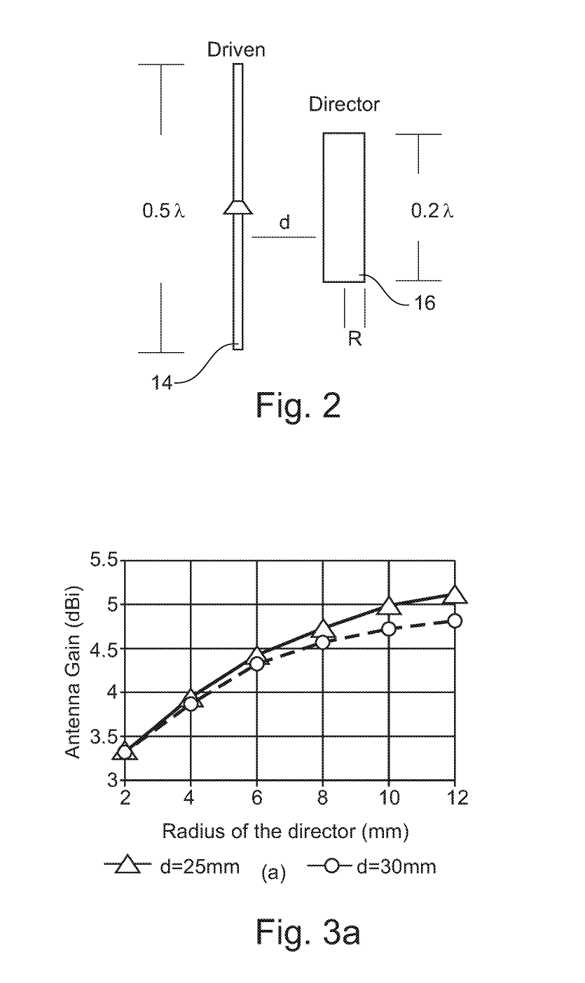

FIG. 2. is a schematic diagram of an antenna assembly according to an embodiment of the invention;

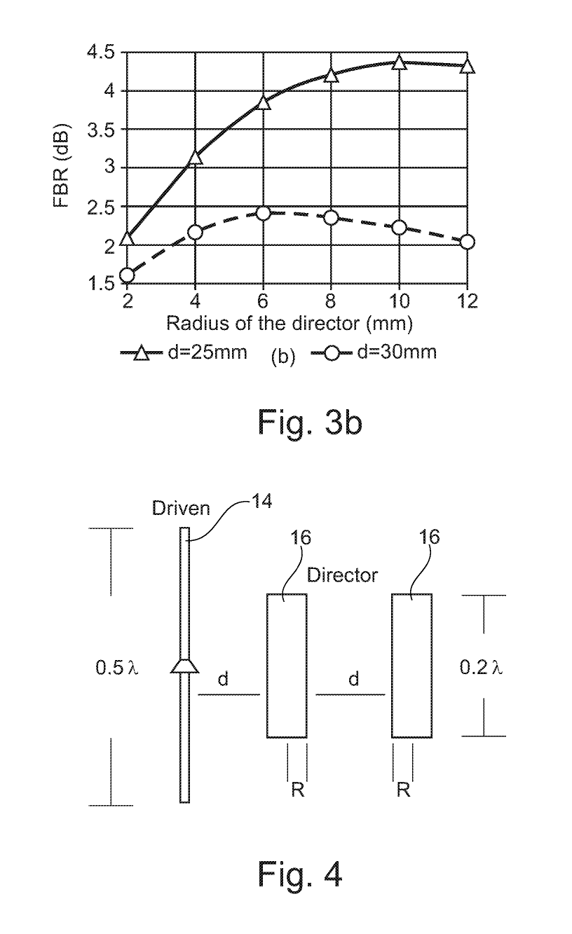

FIG. 3. are graphs showing (a) the realized antenna gain and (b) FBR versus the radius of the small director of the embodiment of FIG. 2 at 2.4 GHz.

FIG. 4. is a schematic diagram of an antenna assembly according to an embodiment of the invention;

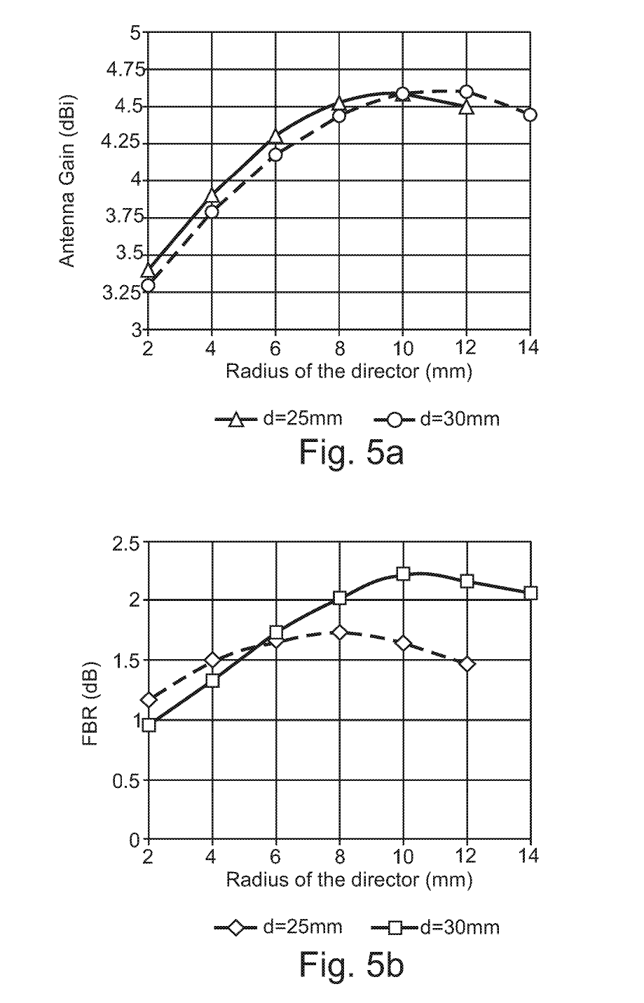

FIG. 5. are graphs showing (a) the realized antenna gain and (b) FBR versus the radius of the small director at 2.4 GHz for the two electrically small directors of the embodiment of FIG. 4;

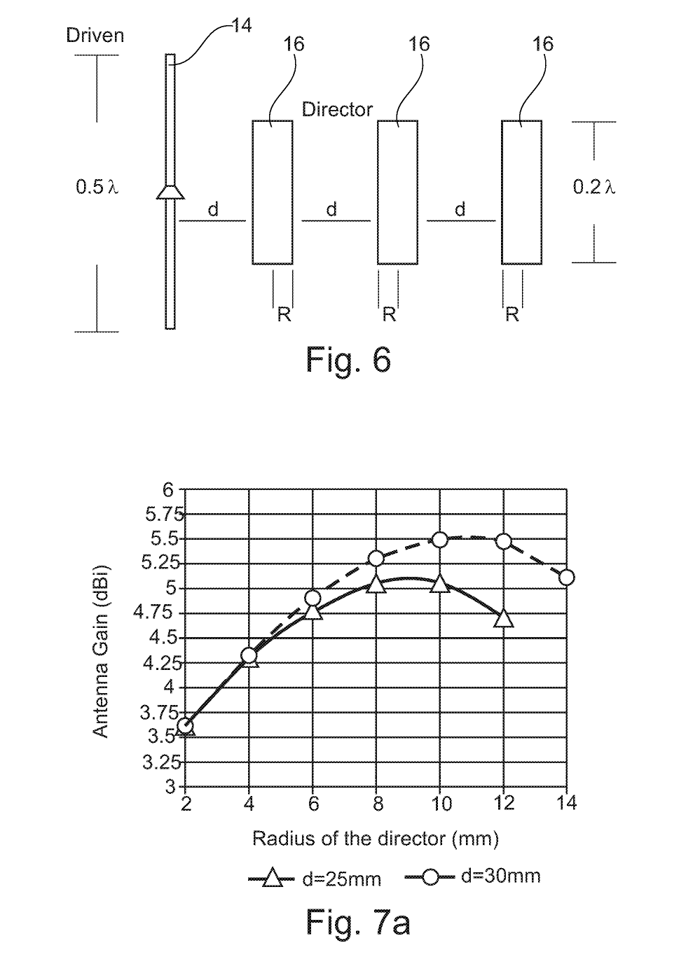

FIG. 6. is a schematic diagram of an antenna assembly according to an embodiment of the invention;

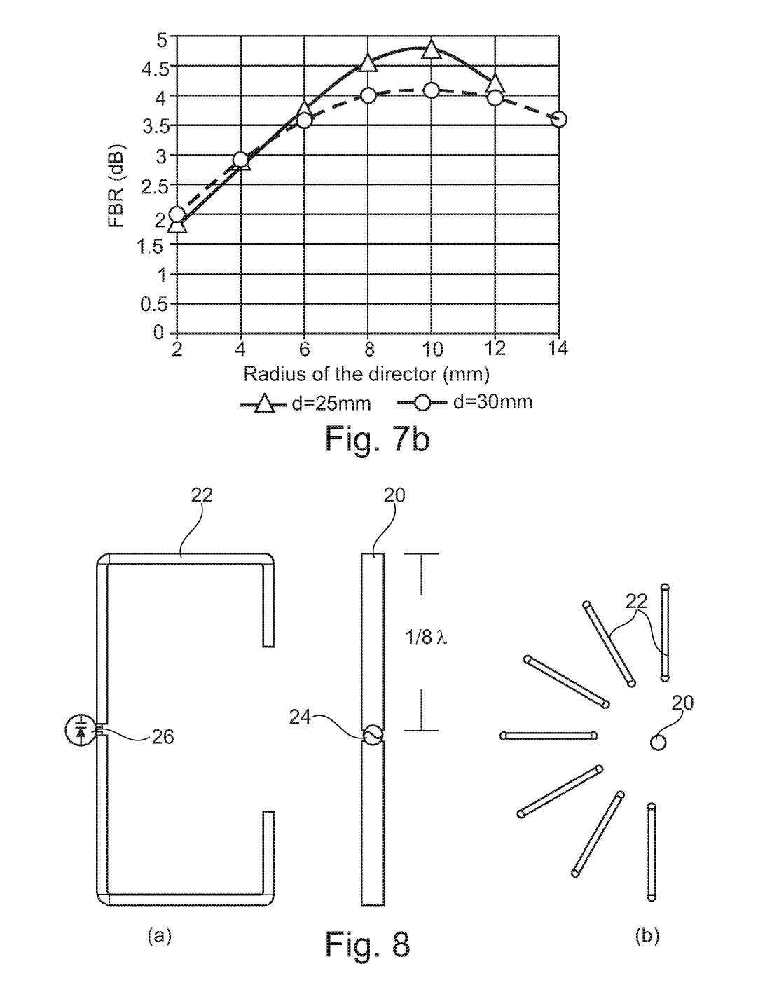

FIG. 7. are graphs showing (a) the realized antenna gain and (b) FBR versus the radius of the small director at 2.4 GHz for the three electrically small directors of the embodiment of FIG. 6;

FIG. 8. is a schematic diagram of a driven component in accordance with an embodiment of the invention, in which (a) is a side view, and (b) is a top view;

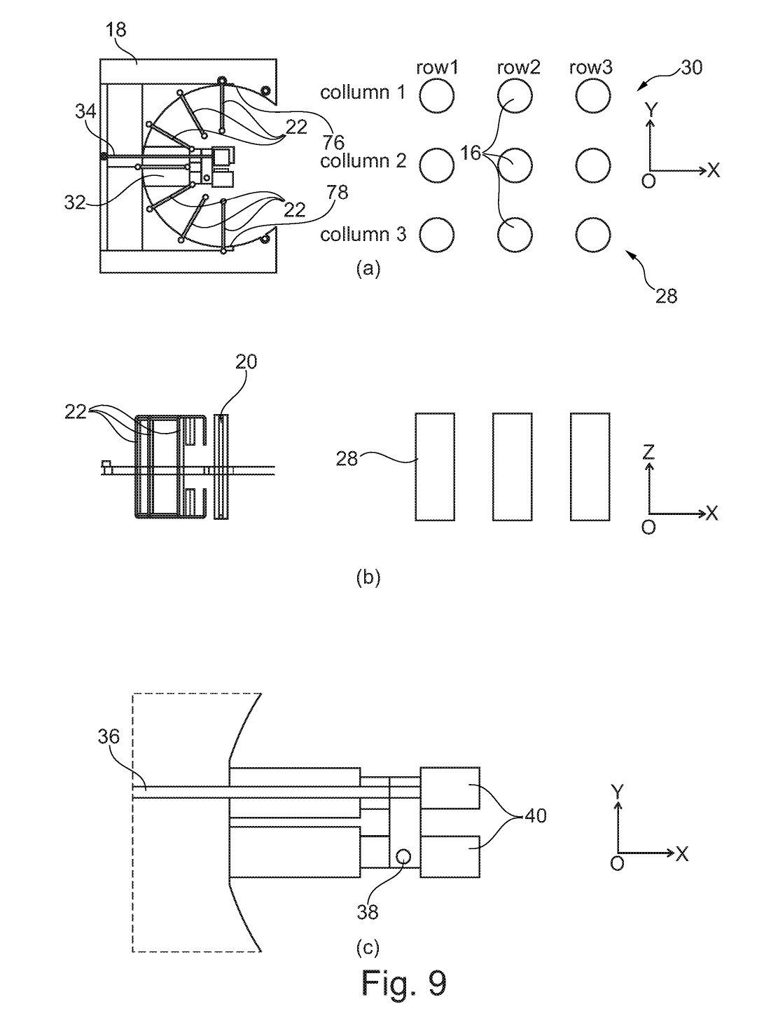

FIG. 9. is a schematic diagram of an antenna assembly according to an embodiment of the invention, in which (a) is a top view, (b) is a side view, and (c) is a detailed structure of a printed balun of the assembly;

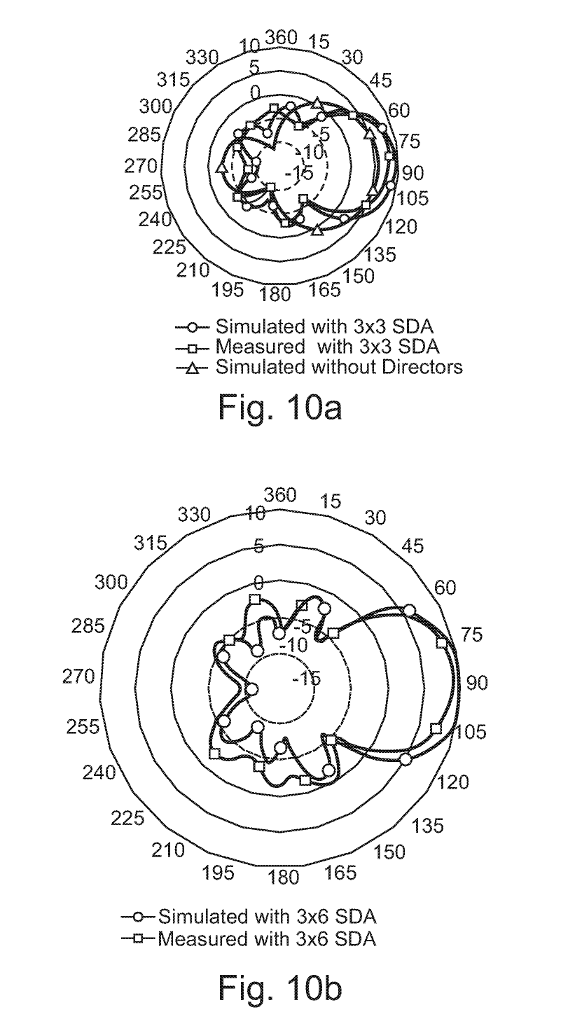

FIG. 10. are graphs showing measured radiation patterns of antenna assemblies according to embodiments of the invention including: (a) a 3×3 fixed SDA, and (b) a 3×6 fixed SDA;

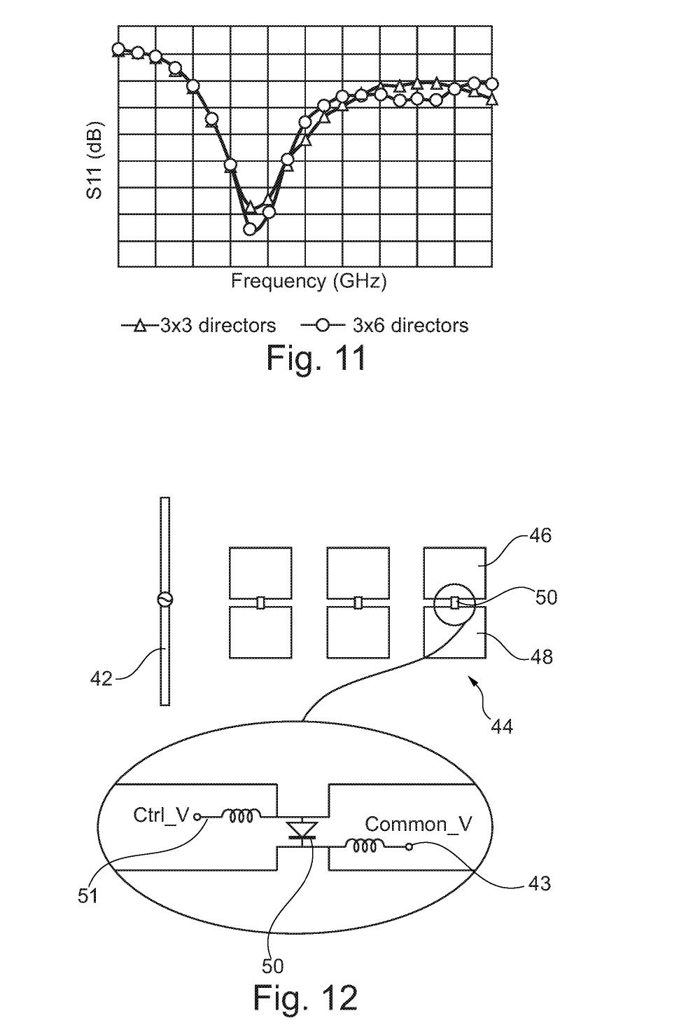

FIG. 11. is a graph showing the measured S₁₁ of antenna assemblies according to embodiments of the invention with different SDA configurations;

FIG. 12. is a schematic diagram of an antenna assembly according to an embodiment of the invention;

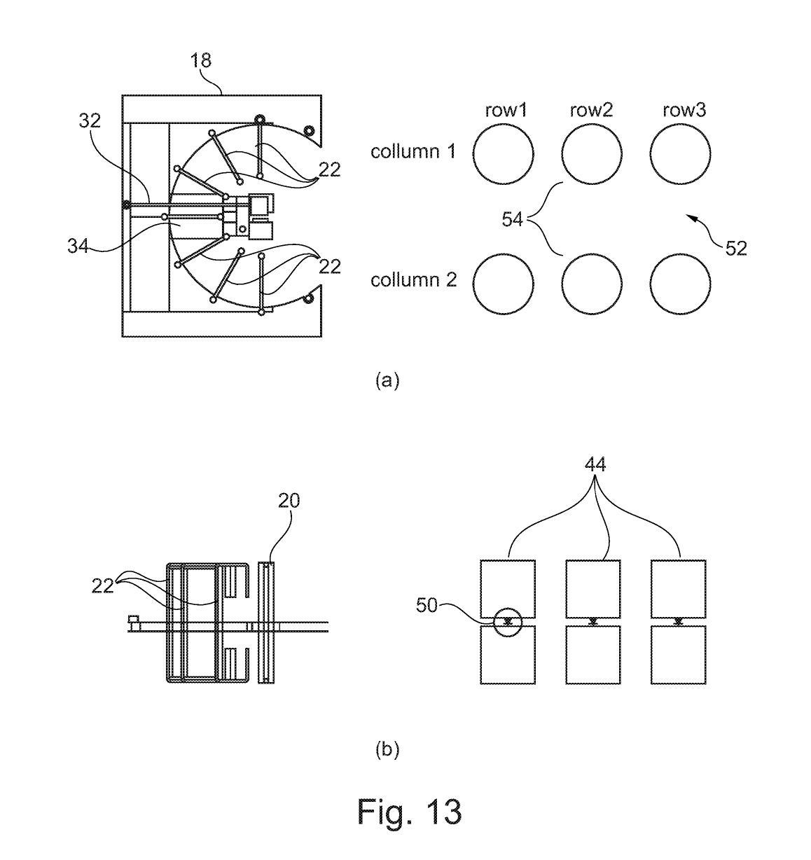

FIG. 13. is a schematic diagram of an antenna assembly according to an embodiment of the invention in which (a) is a top view, and (b) is a side view

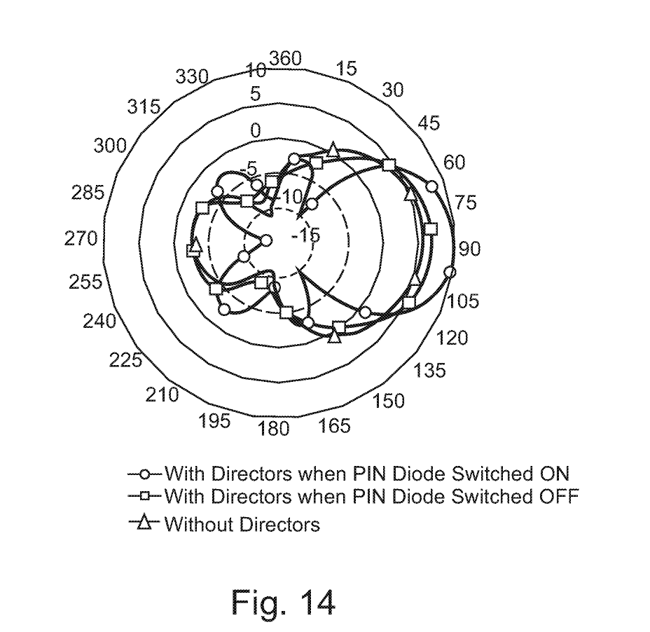

FIG. 14. is a graph showing a simulated radiation pattern of the low profile Yagi-Uda antenna of the embodiment of FIG. 13 when the PIN diodes are forward biased and reverse biased;

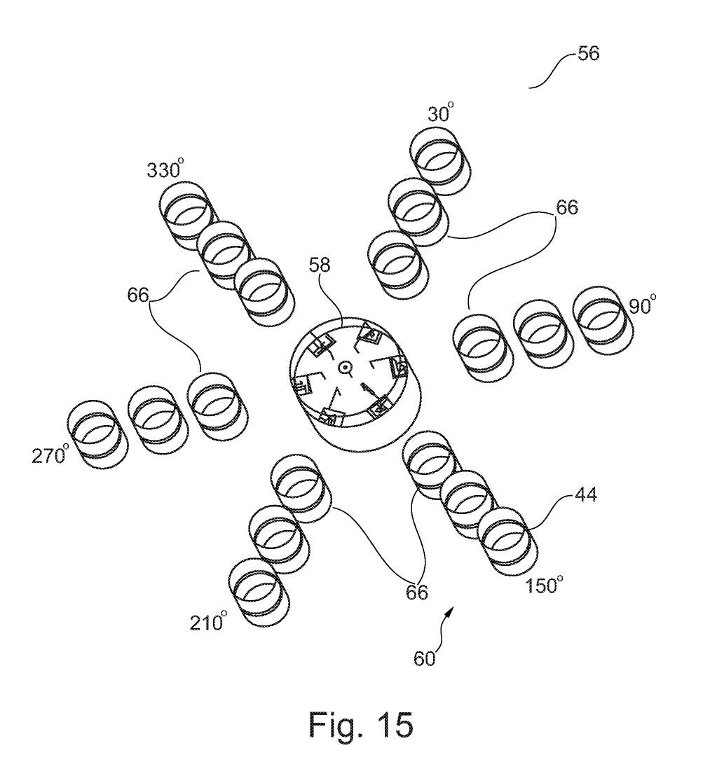

FIG. 15. is a schematic diagram of an antenna assembly according to an embodiment of the invention;

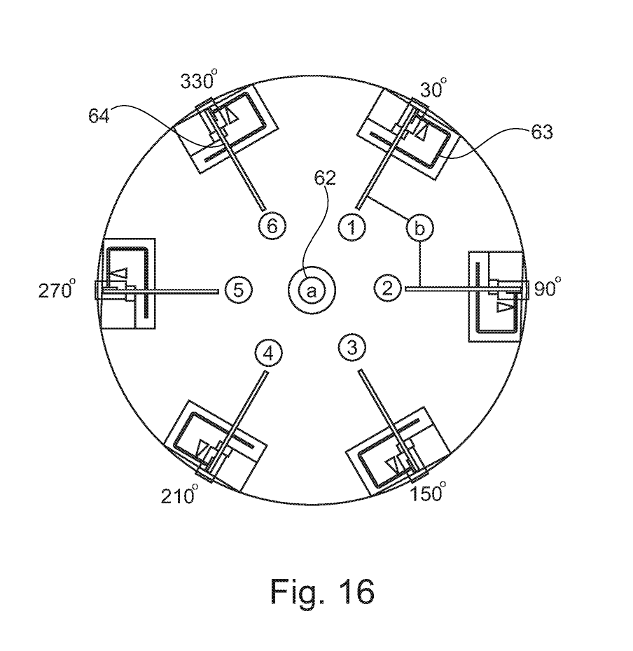

FIG. 16. is a plane view of the low-profile folded monopole switched parasitic antenna of the embodiment of FIG. 15;

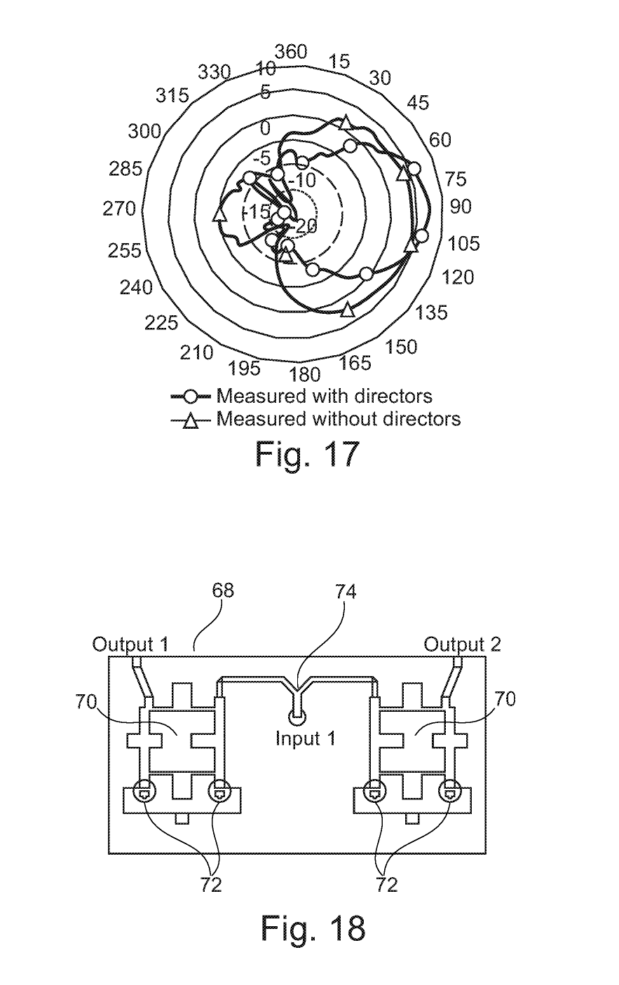

FIG. 17. is a graph showing the measured radiation patterns of the small smart antenna of the embodiment of FIGS. 15 and 16 with and without the reconfigurable SDA;

FIG. 18. is a schematic diagram of a compact variable reactance reflection phase shifter according to an embodiment of the invention;

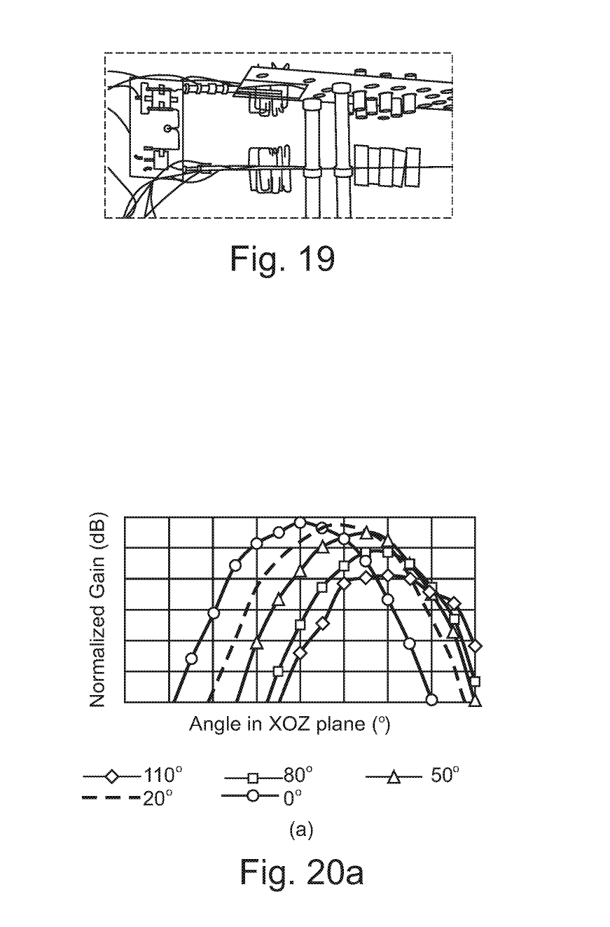

FIG. 19. is a photograph of an antenna system according to an embodiment of the invention;

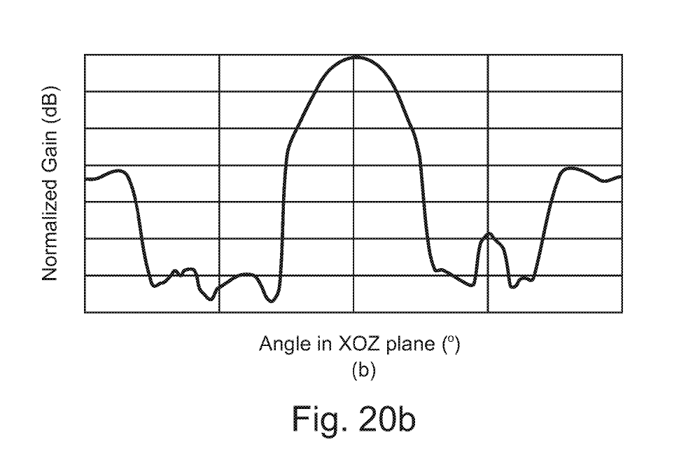

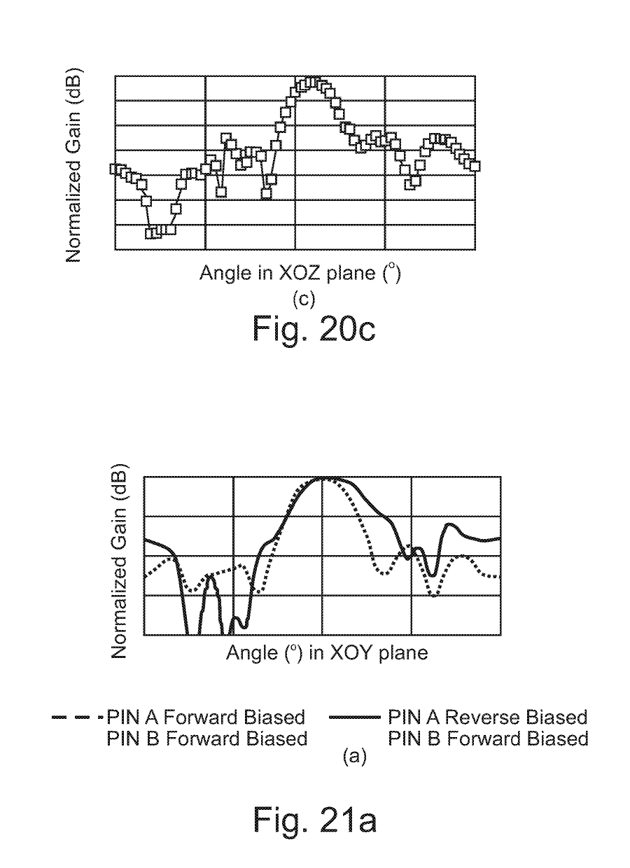

FIG. 20. are graphs showing measured pattern steering in XOZ plane in which (a) shows steered pattern with different phase shifts, (b) shows steered pattern at 0° with 0° phase-shift provided by phase shifters, (c) shows steered pattern at 18° with 80° phase-shift provided by phase shifters;

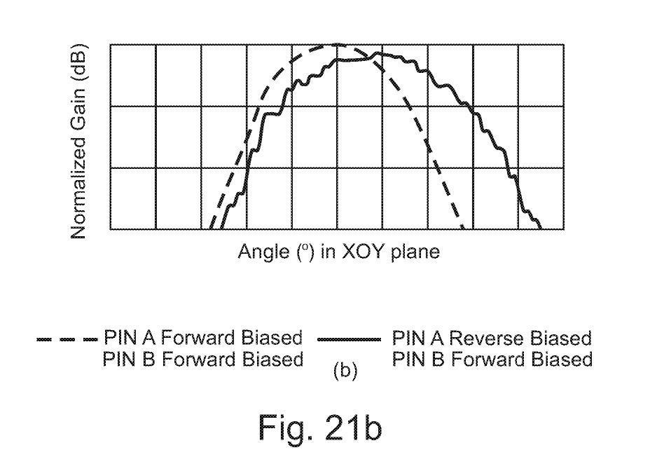

FIG. 21. are graphs showing measured pattern switching in XOY plane in which (a) is pattern from −180° to 180°, and (b) is pattern close view between −90° and 90°; and

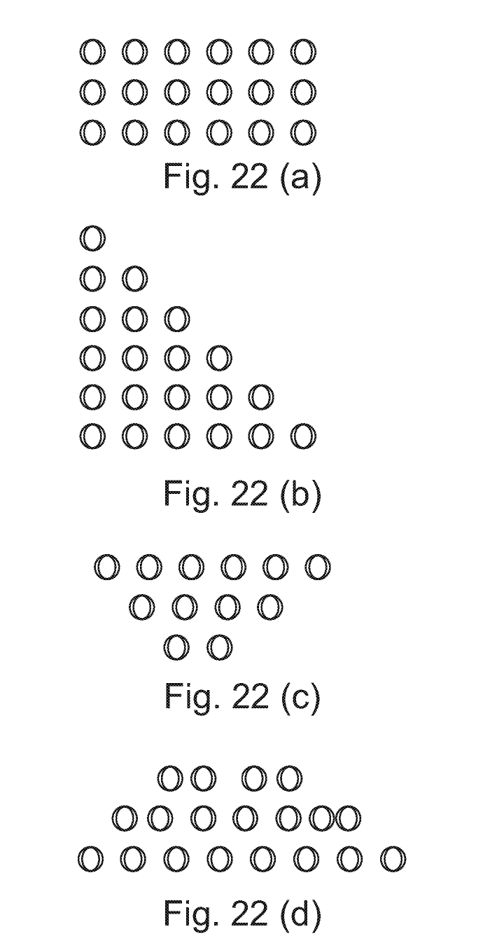

FIG. 22. are examples of director array configurations.

Electrically Small Director

A director is a closely coupled parasitic element that pulls an antenna radiation pattern from a driven element towards a parasitic element along an axis perpendicular to the antenna. It directs a beam along the axis perpendicular to the driven dipole antenna, from the reflector through the driven element and out via the directors. Typically only one reflector is used in Yagi-Uda antennas because the radiation in the direction of the reflector is effectively suppressed by it and more reflectors behind the first reflector cannot significantly increase the gain of the antenna. By contrast, multiple directors are used in the Yagi-Uda antenna and its gain can be increased significantly by increasing their number. This is because the directors aligned in parallel perpendicular to the direction of radiation and can be excited efficiently. In terms of increasing the gain of an antenna, the optimally designed directors are more important than a reflector.

For a standard Yagi-Uda antenna, the driven element is a 0.5λ dipole antenna with narrow diameter, the directors are slightly shorter than the driven element and the typical value is 0.45λ. The size of a standard director is too large for an electrically small smart antenna. However, as discussed below, embodiments of the invention are able to provide the small directors with a height of no more than 0.2λ.

With reference to FIG. 1., an induced current and mutual coupling study between the driven and parasitic elements is described. In FIG. 1 the driven element is marked “10” and the current along it is I₁, its self-impedance is Z₁₁. The voltage at the input port is represented by U. The parasitic element is marked “12” and the current along it is I₂ and its self-impedance is Z₂₂. The mutual coupling impedance between the driven element and the parasitic element is Z₁₂=Z₂₁. There is no external exciting source for the parasitic element, therefore the input voltage for the parasitic element is zero.

$$\{ \begin{matrix}U = {Z}_{11} {I}_{1} + {Z}_{12} {I}_{2} \\ 0 = {Z}_{21} {I}_{1} + {Z}_{22} {I}_{2}\end{matrix} \qquad ( 1 )$$

The induced current along the parasitic element can be calculated from (1).

$$\begin{matrix}{I}_{2} = - \frac{{Z}_{21}}{{Z}_{22}} {I}_{1} = m {e}^{jβ} {I}_{1} \\ where & ( 2 ) \\ {Z}_{21} = {R}_{21} + j {X}_{21} & ( 3 ) \\ {Z}_{22} = {R}_{22} + j {X}_{22} & ( 4 ) \\ m = - \sqrt{\frac{{R}_{21}^{2} + {X}_{21}^{2}}{{R}_{22}^{2} + {X}_{22}^{2}}} & ( 5 ) \\ β = π + {tg}^{- 1} ( \frac{{X}_{21}}{{R}_{21}} ) - {tg}^{- 1} ( \frac{{X}_{22}}{{R}_{22}} ) & ( 6 )\end{matrix}$$

In the above equations, tg means tangent and tg⁻¹ means arctangent. In addition, for an impedance Zₙₘ, Rₙₘ is the resistance of Zₙₘ and Xₙₘ is the reactance of Zₙₘ.

A director shorter than λ/2 has a capacitive reactance and its current phase leads its voltage phase [7]. Therefore for a director, the β in (6) should obey −π<β<0. The factor m in (5) represents the coupling strength between the driven element and the parasitic element. The factor m affects the gain of the antenna. A larger absolute value of m results in a stronger induced current on the director. To design a proper director for the electrically small dipole, a mutually optimized combination of β and m must be identified. The driven element, which is a standard λ/2 dipole antenna, is modeled using CST MICROWAVE STUDIO (CST-MWS). The director is modeled as a Perfect Electrical Conductor (PEC) cylinder with variable radius and variable distance from the driven element. The self-impedance of the driven element and the director are calculated by CST-MWS. The amplitude and the phase of the induced current on the director is calculated by (5) and (6). The calculated m in (5) and β in (6) are presented in Table-I.

TABLE I
INDUCED CURRENT PHASE LEADING
AND ITS AMPLITUDE ON DIRECTORS
2.4 GHz Z₁₁ = 63.68 − 13.2i
2.5 GHz Z₁₁ = 72.16 + 1.70i

| d | R | Freq | | zₘ | | β |
|---|---|---|---|---|---|---|
| (mm) | (mm) | (GHz) | Z₂₂ | (Z₁₂&Z₂₁) | m | (°) |
| 23 | 2 | 2.4 GHz | 6.8 − 107.2i | 19.3 − 12.7i | −0.2 | −127.1 |
| 23 | 2 | 2.5 GHz | 7.6 − 100.2i | 10.0 − 11.8i | −0.2 | −143.9 |
| 21 | 4 | 2.4 GHz | 4.5 − 48.2i | 14.9 − 12.0i | −0.4 | −134.1 |
| 21 | 4 | 2.5 GHz | 5.1 − 44.8i | 46.0 − 0.2i | −1.0 | −96.7 |
| 19 | 6 | 2.4 GHz | 3.2 − 23.9i | 12.6 − 10.1i | −0.7 | −136.3 |
| 19 | 6 | 2.5 GHz | 3.6 − 21.9i | 10.1 − 10.7i | −0.7 | −145.9 |
| 17 | 8 | 2.4 GHz | 2.3 − 12.4i | 10.9 − 8.3i | −1.1 | −137.6 |
| 17 | 8 | 2.5 GHz | 2.6 − 11.1i | 9.5 − 8.8i | −1.1 | −145.7 |
| 15 | 10 | 2.4 GHz | 1.7 − 6.1i | 9.2 − 6.2i | −1.7 | −139.9 |
| 15 | 10 | 2.5 GHz | 1.9 − 5.1i | 8.4 − 6.4i | −1.9 | −148.0 |
| 13 | 12 | 2.4 GHz | 1.3 − 1.8i | 6.8 − 2.9i | −3.3 | −148.7 |
| 13 | 12 | 2.5 GHz | 1.4 − 0.0i | 6.7 − 1.5i | −3.9 | −158.0 |
| 11 | 14 | 2.4 GHz | 1.0 + 0.1i | 5.4 + 0.7i | −5.4 | −176.6 |
| 11 | 14 | 2.5 GHz | 1.1 + 0.8i | 6.2 + 2.2i | −4.9 | −197.6 |

In Table-I, one driven element and one director are considered. d is the distance between the driven element and the director and R is the radius of the PEC cylinder. Z₁₁ is the self-impedance of the driven element and Z₂₂ is the self-impedance of the PEC cylinder. Zm is the mutual impedance between the driven element and the director. Table-I shows that when the radius of the PEC cylinder increases, its self-impedance reduces and m increases, whose absolute value represents the amplitude of the induced current on the PEC cylinder. This means that a thicker PEC cylinder is more efficient in terms of energy coupling. The phase of the induced current in Table-I meets the requirement of phase shift for the director except for the PEC cylinder with radius of 14 mm at 2.5 GHz.

In Table-I the ideal phase shift occurs for the PEC cylinder with radius of 4 mm at 2.5 GHz, which is the most close to −90° [8]. The phase shift produced by the PEC cylinder with radius of 14 mm at 2.5 GHz frequency lies outside the phase shift requirement of the director in (6). Therefore the radius of 14 mm is the upper boundary of a PEC cylinder if it is to serve as the director in this scenario.

To validate the realized gain of this model and the corresponding front-to-back ratio (FBR), a few embodiments of the invention are shown in FIGS. 2, 4, and 6. In each case, a driven element 14 is a standard λ/2 dipole with 0.5 mm radius and a director 16 is a PEC cylinder. The length of the PEC cylinder 16 is set to 25 mm, i.e. 0.2λ at 2.4 GHz. The radius of the small director 16 is R and the distance between the driven element 14 and the director 16 is d. The realized antenna gain and FBR are examined by varying R where the distance between the centre of all elements, d is fixed in these embodiments. Modeling was undertaken for two fixed distances: 25 mm (d=25 mm, i.e. 0.2λ at 2.4 GHz) and 30 mm (d=30 mm, i.e. 0.24λ at 2.4 GHz). To prevent the two directors merging with each other, the radius of the directors has the upper limit of 12.5 mm and 15 mm respectively for the two scenarios above.

FIG. 2 shows an embodiment of an antenna assembly including one electrically small director.

FIG. 3 (a) shows that the realized antenna gain increases when R increases from 2 mm to 12 mm. In FIG. 3 (b), the FBR of the antenna stops increasing when the radius of the director reaches 10 mm.

FIG. 4 shows an embodiment of an antenna assembly including two electrically small directors. In FIG. 4, one driven element 14 and two directors 16 are modeled in CST-MWS. The antenna exhibits similar antenna gain in the two embodiments of FIGS. 2 and 4. The antenna gain increases with the radius of the director 16 when the radius is between 2 mm and 10 mm. As depicted in FIG. 5 the scenario of “d=30 mm” exhibits a better FBR performance than the scenario of “d=25 mm”. Therefore, in this embodiment where there are two electrically small directors 16 considered, the scenario of “d=30 mm” is chosen.

FIG. 6 shows an embodiment of an antenna assembly including three electrically small directors. As depicted in FIG. 7, the antenna gain increases with the radius of the directors 16 when the radius of the director 16 increases from 2 mm to 10 mm. The antenna gain starts to decrease when the radius of the director 16 increases above 10 mm. So does the FBR of the antenna. For one driven element 14 and three electrically small directors 16, the scenario of “d=30 mm” shows a higher gain than the scenario of “d=25 mm”. On the other hand, the scenario of “d=25 mm” represents a better FBR than the scenario of “d=30 mm”.

Balancing the antenna gain and the FBR performance, embodiments of the invention are arranged with the distance between directors 16 as d=25 mm, which is as same as the empirical value.

The structure of a driven component in the form of a low profile source antenna 18, which can be used to illuminate a 3×3 fixed SDA, is given in FIG. 8. FIG. 8 shows an electrically small driven element 20 and reflectors 22. It comprises a quarter-wave short dipole 20 with 2 mm radius, whose height has been reduced by 50% comparing with standard half-wave dipole. The short dipole 20 serves as the driven element and it is the only element connected with a 50Ω coaxial cable. Seven folded dipoles 22 with height of λ/4 serve as parasitic elements and partially circularly surround the driven element 20 is this example forming a semi-circle around the driven element 20. The folded dipoles 22 are bent towards the driven element 20. An RF source feeding position 24 and series PIN diodes 26 are also shown. With the capacitance load provided by the folded monopoles 22, the antenna 18 height has been significantly reduced.

The low profile source antenna 18 in FIG. 8 and a 3×3 fixed SDA 28 together forms a low profile Yagi-Uda antenna or antenna assembly 30 as shown in FIG. 9. A printed balanced unbalanced transformer (balun) 32 is used to feed the structure shown in FIG. 8. As per FIG. 8, the electrically small dipole antenna 20 has a length of ¼ λ and 2 mm radius and is surrounded by folded dipoles. The SDA 28 comprises an array of nine directors 16, such as described in respect of FIGS. 2, 4 and 6, arranged in a grid of three rows by three columns. In this example, the rows are parallel and the columns are parallel, and the rows are perpendicular to the columns. The SDA 28 is arranged with respect to the source antenna 18 so that the SDA 28 is separated from the source antenna 18 along a direction along which the source antenna can receive or emit radiation. In particular, the directors 16 of column 2 of FIG. 9(a) are aligned along a direction along which the source antenna 18 can receive or emit radiation. The diameter of the small directors 16 is 10 mm and the distance between those small directors is 25 mm. The distance between the low profile source antenna 18 and the 3×3 fixed SDA 28 is 40 mm which is optimized for achieving the best FBR.

FIG. 9(c) shows a detailed structure of the printed balun 32. The printed balanced unbalanced transformer (balun) 32 includes a feeding microstrip line 34, a printed microstrip line 36 on a top-layer of the balun, a via hole 38, and two-arms 40 of the balun on a bottom-layer.

One advantage of the low profile Yagi-Uda antenna in FIG. 9 is that those small directors 16 exist in the same direction with its main lobe. Unlike a Yagi-Uda microstrip patch antenna array [9], [10], there is an angle between the direction of its main lobe and the direction in which the parasitic patch antennas lineup. Therefore, the directivity of the array factor introduced by SDA is hence a superposition of the directivity of the radiation pattern from driven element. This is the most efficient scenario for antenna gain increase.

The radiation pattern was measured at the National Physical Laboratory (NPL, UK) by using a Vector Network Analyzer (VNA) through an Opto-Electric Field Sensor (OEFS) system [12], [13], which consists of an RF-to-optical transducer, optical fiber and an OEFS controller. The antenna is connected to the RF-to-optical transducer and then to the OEFS controller via the optical fiber. This allows non-intrusive antenna pattern measurements by eliminating unwanted common mode effects that would be introduced by using a coaxial cable to feed the antenna under test. The measured and simulated radiation pattern of the low profile Yagi-Uda antenna 30 steered at 90° is given in FIG. 10(a). In FIG. 10(b), the measured and simulated radiation pattern for another embodiment is provided. The embodiment simulated and measured for FIG. 10(b) corresponds to the embodiment of FIG. 9, except that it has a 3×6 fixed SDA. The measured S₁₁ for the embodiments measured in FIG. 10 is given in FIG. 11. From FIG. 10(a), comparison between the radiation patterns of the low profile Yagi-Uda antenna 30 with and without the 3×3 fixed SDA shows that the antenna gain was increased by 3 dB and the FBR of the antenna improved as well. Furthermore, the antenna exhibits 9.2 dBi realized gain and 25 dB FBR with 3×6 fixed SDA and 8.0 dBi gain and 13 dB FBR with 3×3 fixed SDA.

Reconfigurable Electrically Small Director and Reconfigurable SDA

A reconfigurable small director and a reconfigurable SDA are used in pattern steering antennas, whose beam can be steered from 0° to 360° in the horizontal plane. A reconfigurable SDA can be controlled to increase radiation power in the forward direction only. In addition, the radiation power in backward and other unwanted directions will not be increased.

The structure of an antenna assembly including a reconfigurable small director according to an embodiment is shown in FIG. 12. An antenna assembly includes a half-wave dipole 42 to serve as a driven element and a plurality of reconfigurable directors 44 aligned in a direction along which the dipole 42 can emit or receive radiation. Each of the directors 44 includes a first or upper hollow cylinder 46, and a second or lower hollow cylinder 48. The dimensions of the directors 44 can correspond to the dimensions given for the directors 16 described above. The upper and lower hollow cylinders are connected by PIN diodes 50. The PIN diodes 50 are controlled by a DC control voltage feeder 51 and a common DC control voltage feeder 53. When the PIN diodes are forward biased, the reconfigurable small directors 44 perform akin to the fixed small directors 16 described above. Furthermore, the antenna gain can be increased significantly. When the PIN diodes 50 are reverse-biased, the induced currents along the reconfigurable small directors 44 are attenuated by the PIN diodes 50 [11]. Therefore, the amplitudes of the induced currents along these small directors are very small and the antenna gain remains nearly unchanged. All PIN diodes have been calibrated in terms of the “Reverse Series Resistance” before soldering.

An embodiment of an antenna assembly 52 including a 2×3 reconfigurable SDA 54 is shown in FIG. 13. The assembly 52 includes a source antenna 18 which is used to illuminate the 2×3 reconfigurable SDA and which is the same low profile antenna as described above in respect of FIGS. 8 and 9. Six reconfigurable small directors 44 such as described in respect of FIG. 12 are arranged as a 2×3 SDA 54. The radius of the reconfigurable small directors 44 is 10 mm and the distance between them is 25 mm.

The simulated radiation patterns of the low profile Yagi-Uda antenna 52 consisting of a 2×3 reconfigurable SDA are given in FIG. 14. The radiation pattern when the PIN diodes are forward biased is compared with the case where the PIN diodes are reverse biased. The radiation pattern of the low profile antenna when no reconfigurable SDA are employed is given in FIG. 14 as well.

In FIG. 14, the low profile Yagi-Uda antenna 54, which consists of a 2×3 reconfigurable SDA, yields a 10.0 dBi antenna gain when the PIN diodes are forward biased and a 6.7 dBi antenna gain when the PIN diodes are reverse biased. The antenna gain of the low profile antenna 18 used to illuminate the 2×3 reconfigurable SDA 54 is 6.0 dBi. The antenna gain increases by 4 dB on account of the reconfigurable SDA 54 when the PIN diodes are forward biased. The FBR of the antenna is improved as well by employing the reconfigurable SDA with forward biased PIN diodes.

In another embodiment of the invention, an antenna assembly 56 includes a driven element being a pattern steering small smart antenna in the form of a folded monopole switched parasitic antenna 58, and a reconfigurable SDA 60 deployed around the folded monopole switched parasitic antenna with a “Star Topology” distribution. The 3D structure of the folded monopole switched parasitic antenna and the reconfigurable SDA in “Star Topology” is shown in FIG. 15.

The folded monopole switched parasitic antenna 58 in FIG. 15 is a low profile antenna with a 0.1λ antenna height, whose beam can be steered from 0° to 360° in the horizontal plane. The folded monopole switched parasitic antenna 58 is placed over a 0.1λ high skirt ground plane and circularly surrounded by a reconfigurable SDA in “Star Topology” as illustrated in FIG. 15. The folded monopole switched parasitic antenna 58 consists of one top-disk-loaded short monopole antenna 62 at the centre as a driven element and seven folded monopole antennas 64 circularly surrounding the centre as parasitic elements. A one-quarter wavelength high impedance transmission line 63 isolating DC control line and DC filter from monopole. The plane view of the folded monopole switched parasitic antenna is given in FIG. 16 together with its angle coordinate definition.

As can be seen from FIG. 15, in this embodiment the SDA 60 includes 6 groups 66 of directors 44, although in modifications there can be more or fewer than 6 groups. The directors 44 are reconfigurable directors 44 as described above. Each of the groups of the directors 44 includes 3 directors, although in modifications, each group of directors 44 can include more or fewer than 3 directors. The directors 44 of each group of directors 66 are aligned along a direction along which the folded monopole switched parasitic antenna 58 can emit or receive radiation.

The groups 66 of directors are angularly spaced around the folded monopole switched parasitic antenna. In this example, there is a group of directors which is radially aligned with each of the folded antennas 64 of the folded monopole switched parasitic antenna 58. Accordingly, the angular spacing between the groups of directors corresponds to the angular spacing between the folded antennas 64 of the folded monopole switched parasitic antenna 58. Each folded monopole antenna 64 in the folded monopole switched parasitic antenna 58 and the three reconfigurable small directors 44 in the group 66 which is aligned at the same angle coordinates are controlled by a DC control voltage simultaneously. The beam directions and its corresponding control voltage configuration are given in Table-II.

TABLE II
BEAM DIRECTION AND CONTROL
VOLTAGE CONFIGURATION

| Beam | | | | | | |
|---|---|---|---|---|---|---|
| Direction | V1 | V2 | V3 | V4 | V5 | V6 |
| 30° | 22 V | 0 V | 0 V | 0 V | 0 V | 0 V |
| 90° | 0 V | 22 V | 0 V | 0 V | 0 V | 0 V |
| 150° | 0 V | 0 V | 22 V | 0 V | 0 V | 0 V |
| 210° | 0 V | 0 V | 0 V | 22 V | 0 V | 0 V |
| 270° | 0 V | 0 V | 0 V | 0 V | 22 V | 0 V |
| 330° | 0 V | 0 V | 0 V | 0 V | 0 V | 22 V |

The measured radiation patterns of the folded monopole switched parasitic antenna 58 with and without the reconfigurable SDA in the “Star Topology” are given in FIG. 17. The antenna gain is increased by 3 dB on account of the reconfigurable SDA 60. The FBR of the antenna is improved significantly as well.

Reconfigurable Electrically Small Director with Two Fixed SDAs

Embodiments of the invention provide an antenna system including reconfigurable small directors with an array consisting of two SDAs, which enable the steering of the radiation pattern in the whole of azimuth plane and part of elevation plane. However, although orientations with respect to the vertical are described herein, this is simply for convenience of description. The antenna assemblies and systems described herein can be oriented in different directions, which will cause the directions to change accordingly. Furthermore, although the system is described with two SDAs, more than two can be used in other embodiments. In order to sweep in the XOZ plane shown in FIG. 9, a phase shifter can be used to couple together a plurality of antenna assemblies such as those described above.

In an embodiment of the invention, an antenna system is provided as shown in FIG. 19. The antenna system includes two antenna assemblies according to the embodiment of FIG. 9. The antenna assemblies are arranged so that their antenna planes are parallel, the antenna planes being the planes in which the components of the individual antenna assemblies are disposed. That is to say the planes in which the individual antenna assemblies are operable to emit and receive radiation. A compact, low-cost variable reactance reflection phase shifter 68 comprising a branch-line coupler 70, a Wilkinson power divider 14, and soldered varactors 72 can provide the phase shift for a two-element array consisting of two fixed SDAs. The phase shifter is shown in FIG. 18.

The compact branch-line coupler 70 is constructed by folded-lines which can give a very compact structure [14], [15]. The varactor 72 used is Toshiba 1SV287FCT-ND and the phase shift versus the DC control voltage is given in Table-III. The radiation pattern of the antenna system can be steered in XOZ plane between −20° and 20°. The measured radiation from 0° to 20° in XOZ plane is given in FIG. 20. The corresponding phase-shifts provided by phase shifters are from 0° to 110°. The radiation pattern between −20° and 0° can be steered when the phase shifters providing symmetry phase-shifts from −110° to 0°.

TABLE III
THE PHASE SHIFT AT 2.35 GHz AND 2.4 GHz

| DC | Phase | Phase |
|---|---|---|
| voltage | Shift (°) | Shift (°) |
| (V) | (2.35 GHz) | (2.4 GHz) |
| 0.0 | 9.3 | −3.8 |
| 3.0 | 24.0 | 11.4 |
| 5.0 | 38.0 | 24.7 |
| 7.0 | 60.1 | 43.7 |
| 10.0 | 98.1 | 74.0 |
| 14.0 | 127.5 | 98.7 |
| 16.0 | 136.1 | 106.5 |
| 18.0 | 142.7 | 112.7 |
| 20.0 | 148.3 | 117.8 |
| 22.0 | 152.2 | 122.1 |

Two general purpose PIN diodes 76, 78 (BAP50-02) shown in FIG. 9 can be used to switch the radiation pattern in the XOY plane. The diode forward impedance of BAP50-02 is (2.7+21.2i) Ω when the PIN diode is forward biased. The typical diode impedance is (81.1+290.1 i) Ω when the PIN diode is reverse biased.

When both PINS 76, 78 are forward biased, the radiation pattern points at 0° in XOY plane. A switched radiation pattern pointing at 10° in XOY plane, with PIN 76 reverse biased and PIN 78 forward biased, is given in FIG. 21. When symmetrically setting PIN 76 and PIN 78 by PIN 76 forward biased and PIN 78 reverse biased, the radiation pattern can be steered at −10° in XOY plane.

Although dimensions are described above in terms of millimetres, these are provided specifically for the wavelengths at which the above described embodiments are configured to operate. In other embodiments which are configured to operate at different wavelengths, these dimensions will need to be adapted accordingly.

Where above a dipole is described, this can be replaced by a monopole coupled to a ground plane. Additionally, where a monopole is described as being coupled to a ground plane, this can be replaced by a dipole.

In the embodiments described above, director arrays of a particular configuration are described. However, the number of rows and columns of directors in the director arrays can be varied and the numbers of directors in each row and column can be varied. Examples of director array configurations are shown in FIG. 22, in which in each case the driven component can be preferably located to the left of the arrangement.

In the embodiments described above, the directors are in places described as being cylinders. However, tubes with non-circular cross-sections can also be used. In such cases, the tubes are arranged so that the surface area is equal to the surface area as for the circular cross-sectional case. This can be done by configuring the tubes to have the same height as the tubes in the circular cross-sectional case and a perimeter equal to 2πr where r is the value of a radius for the circular cross-sectional case.

Additionally, although the directors described above are hollow tubes, in some embodiments solid tubes can be used.

Furthermore, the driven components described above can be substituted for different driven components. As explained above, particular advantages are achieved when the driven component is a reconfigurable directional smart antenna.

In this description, the short cylindrical structure that operates as a director for low profile smart antennas has been studied. Various combination of the fixed small director, the fixed SDA, the reconfigurable director and the reconfigurable SDA have been disclosed. The structure used to evaluate the reconfigurable 2×3 SDA produced a low profile Yagi-Uda antenna, with an antenna gain of 10 dBi. The height of the low profile Yagi-Uda antenna was reduced by 50% compared with the standard Yagi-Uda antenna. The reconfigurable SDA was designed to increase the antenna gain for pattern steering small antennas. A reconfigurable SDA with a “Star Topology” was measured together with the folded monopole switched parasitic antenna. The antenna gain of the folded monopole switched parasitic antenna was increased by 3 dB by employing the reconfigurable SDA. The FBR of the folded monopole switched parasitic antenna was improved as well.

Both the fixed SDA and reconfigurable SDA have proved to be low cost and efficient methods to increase the antenna gain for low profile antennas without increasing antenna height. The design methods proposed in this work and demonstrated in these prototypes can form the basis for high gain electrically small Yagi antenna whose antenna gain can be achieved on demand.

Furthermore, a two-element array that is able to electronically steer its radiation pattern in both azimuth and elevation planes has been designed, constructed and measured. This feature makes this two-element array suitable for applications requiring overcoming the pointing loss. The proposed SDA for low profile smart antenna achieving higher gain have the advantages of compact size, low cost, low power consumption.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in British patent application number 1223250.0, from which this application claims priority, and in the abstract accompanying this application are incorporated herein by reference.

### REFERENCES

[1] H. Liu, S. Gao, and T. H. Loh, “Compact Dual-Band Antenna With Electronic Beam-Steering and Beamforming Capability,” IEEE Antennas Wireless Propag. Lett., vol. 10, no. 1, 2011.
[2] H. Liu, S. Gao and T. H. Loh, “Low-Cost Intelligent Antenna with Low Profile and Broad Bandwidth,” accepted for publication in IET Microwave, Antennas and Propagation Journal on 7^{th} Feb. 2012.
[3] J. Lu, D. Ireland, and R. Schlub, “Dielectric Embedded ESPAR (DE-ESPAR) Antenna Array for Wireless Communications,” IEEE Trans. Antennas Propag., vol. 53, pp. 2437-2443, August 2005
[4] D. C. Nascimento, R. Schildberg and J. C. da S. Lacava, “Low-cost Yagi-Uda monopole array” Antennas and Propagation Society International Symposium (IEEE AP-S 2008), pp. 1-4, 5-11 Jul. 2008
[5] S. Lim; H. Ling, “A two-element, electrically small Yagi antenna,” Antennas and Propagation Society International Symposium, (IEEE AP-S 2007), pp. 2455-2458, 9-15 Jun. 2007
[6] S. Lim, H. Ling, “Design of electrically small Yagi antenna,” Electronics Letters, vol. 43, no. 5, pp. 3-4, Mar. 1, 2007
[7] Pozar, David M. (2001). Microwave and RF Design of Wireless Systems. John Wiley & Sons Inc. p. 134. ISBN 978-0-471-32282-5
[8] C. A. Balanis, “Antenna Theory Analysis and Design,” 3nd ed. A JOHN WILEY & SONS, INC., PUBLICATION, pp. 287-289.
[9] D. Gray, J. W. Lu, and D. V. Thiel, “Electronically steerable Yagi-Uda microstrip patch antenna array” IEEE Trans. Antennas Propag., vol. 46, pp. 605-608, 1998.
[10] X. S. Yang, B. Z. Wang, and W. Wu, “Yagi Patch Antenna With Dual-Band and Pattern Reconfigurable Characteristics” IEEE Antennas and Wireless Propagation Letters., vol. 6, pp. 168-171, 2007.
[11]D. V. Thiel, S. Smith. “Switched Parasitic Antennas for Cellular Communications,” Artech House, London, 2001.
[12] T. H. Loh, M. Alexander, P. Miller, and Andrés López Betancort, “Interference Minimisation of Antenna-to-Range Interface for Pattern Testing of Electrically Small Antennas”, 4^{th} European Conference on Antennas and Propagation (EuCAP 2010), Barcelona, Spain, 11^{th}-16^{th} Apr. 2010.
[13]M. Alexander, and T. H. Loh, A. Lopezbetancort, “Measurement of electrically small antennas via optical fibre”, Loughborough Antennas and Propagation Conference (LAPC 2009), Loughborough, UK, 16^{th}-17^{th} Nov. 2009, pp. 653-656.
[14] H. Ghali and T. A. Moselhy, “Miniaturized fractal rat-race, branch-line, and coupled-line hybrids”, IEEE Trans. Microw. Theory Tech., Vol. 52, No. 11, pp. 2513-2520, November 2004.
[15] C. W. Tang, M. G. Chen, “Synthesizing Microstrip Branch-Line Couplers With Predetermined Compact Size and Bandwidth”, IEEE Trans. Microwave Theory and Techniques, Vol. 55, No. 9, pp. 1926-1934, September 2007.
[16] H. Liu, S. Gao, and T. H. Loh, “Small Director Array for Low profile Smart Antennas Achieving Higher Gain”, IEEE Transaction on Antennas and Propagation, Vol. 61, No. 1, January 2013, pp. 162-168.

1-35. (canceled)

36. An antenna assembly, including:
a driven component configured to emit or receive radiation at a wavelength λ; and
a director array disposed in a path along which the driven component is operable to emit or receive radiation to increase a gain of the antenna assembly, the director array including at least one director; wherein every director of the director array has a height of ≦0.3λ.

37. An antenna assembly according to claim 36, wherein the driven component includes a directional smart antenna.

38. An antenna assembly according to claim 37, wherein the driven component includes a reconfigurable smart antenna.

39. An antenna assembly according to claim 36, wherein each director of the director array includes a tube.

40. An antenna assembly according to claim 39, wherein a perimeter of each tube is 2πr where r is from 0.05λ to 0.1λ.

41. An antenna assembly according to claim 39, wherein each director of the director array includes a first tube connected by a PIN diode to a second tube longitudinally offset from the first tube or from a ground plane.

42. An antenna assembly according to claim 41, wherein the antenna assembly includes a control unit operable for each PIN diode selectively to forward bias the PIN diode to put the respective director into a directing mode, or to reverse bias the PIN diode to put the respective director into a non-directing mode.

43. An antenna assembly according to claim 36, wherein:
a distance of the director array from the driven component is from 0.15λ to 0.4λ; or
each director of the director array is switchable between a directing mode in which the director acts as a parasitic director, and a non-directing mode in which the director is substantially transparent to radiation at wavelength λ.

44. An antenna assembly according to claim 36, wherein the director array includes at least one plurality of directors.

45. An antenna assembly according to claim 44, wherein:
a distance between adjacent directors in the director array is substantially the same as a distance of the director array from a driven element; or
each plurality of directors forms an array at least 2 directors wide in a direction perpendicular to a direction along which the driven component is operable to receive or emit radiation.

46. An antenna assembly according to claim 44, wherein the at least one plurality of directors is more than one plurality of directors; wherein the pluralities of directors are angularly spaced around the driven component; and wherein the driven component is operable to receive or emit radiation in the direction of any of the plurality of directors.

47. An antenna assembly according to claim 46, wherein the driven component is operable selectively to receive or emit radiation in the direction of any of the plurality of directors.

48. An antenna assembly according to claim 36, wherein the driven component includes a driven element at least partially surrounded by parasitic elements wherein the parasitic elements are of bent or curved configuration.

49. An antenna assembly according to claim 48, wherein:
the parasitic elements are angularly spaced around the driven element and are bent or curved towards the driven element; or
wherein the driven element and the parasitic elements each include a dipole or a monopole.

50. An antenna assembly according to claim 48, wherein each of the parasitic elements has an adjustable reflectivity, thereby to allow selection of a direction for the driven component to emit or receive radiation.

51. An antenna assembly according to claim 36, wherein each director is substantially parallel to a direction of oscillation of radiation that the driven component is operable to emit or receive.

52. An antenna system including a plurality of antenna assemblies, each antenna assembly of the plurality of antenna assemblies including:
a driven component configured to emit or receive radiation at a wavelength λ; and
a director array disposed in one or more paths along which the driven component is operable to emit or receive radiation to increase a gain of the antenna assembly, the director array including at least one director wherein every director of the director array has a height of ≦0.3λ;
wherein for each antenna assembly of the plurality of antenna assemblies, the driven component and director array are disposed in an antenna plane;
wherein the antenna planes of the plurality of antenna assemblies are arranged in different geometrical planes from each other.

53. An antenna system according to claim 52, wherein:
the director array of each antenna assembly of the plurality of antenna assemblies includes a plurality of directors; or
the antenna planes of the antenna assemblies are substantially parallel.

54. An antenna system according to claim 52, wherein the antenna assemblies are coupled by a phase shifter to allow selection of a direction for receiving or emitting radiation which is not parallel to an antenna plane.

55. A method of operating an antenna assembly, the antenna assembly including:
a driven component; and
a director array including at least one director; wherein every director of the director array has a height of ≦0.3λ; the method including:
operating the driven component to emit or receive radiation at a wavelength λ along a path in which is disposed the director array, thereby to increase a gain of the antenna assembly.
